(19) United States
(12) Patent Application Publication
(10) Pub. No.: US 2010/0004399 A1
(43) Pub. Date: Jan. 7, 2010

(54) Edge Banding

(76) Inventor: Harry V. Empting, JR., Lake City, TN (US)

Correspondence Address: PITTS AND BRITTIAN P C, P O BOX 51295, KNOXVILLE, TN, 37950-1295, US

(21) Appl. No.: 12/165,944

(22) Filed: Jul. 1, 2008

(51) Int. Cl. C08L 33/06

(52) U.S. Cl. 525/221

(57) ABSTRACT

An edge banding comprises an extruded blend of acrylonitrile butadiene styrene and ethylene vinyl acetate.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to semi rigid edge banding.

More particularly, this invention pertains to an improved edge banding comprising a blend of acrylonitrile butadiene styrene (ABS) and ethylene vinyl acetate (EVA).

2. Description of the Related Art

Edge banding is used as a protective and decorative covering for the edge of composite board or plywood, which has a decorative top surface, such as formica laminate, for example. This type of construction is very often used in the production of office furniture. Both the edge banding and the laminate are generally secured to the board with an adhesive. Edge banding is often adhered to the board with an adhesive comprising ethylene vinyl acetate mixed with a filler.

In the past, edge banding has commonly been formed from polyvinyl chloride (PVC). PVC has good abrasion resistance and trims easily. However, PVC does not adhere well unless the edge banding is coated with a primer. More importantly, PVC is dangerous to the environment because, if burned, it decomposes to release chlorine gas, a dangerous chemical.

Acrylonitrile butadiene styrene (ABS) is a thermoplastic random copolymer which is generally environmentally “friendly.” It has been used as a material for edge banding at relatively thin layers, for example up to about 18 mils. However, ABS is too rigid at greater thicknesses to form around a corner having a small radius. In addition, gaps are frequently developed between the edge banding and the board adjacent to each side of the corner. Accordingly, when thicker edge banding is required, corners are generally formed by cutting the edge banding and butting the ends together, an unattractive solution. Also, Acrylonitrile butadiene styrene is subject to stress whitening when it is bent.

### BRIEF SUMMARY OF THE INVENTION

According to one embodiment of the present invention, an improved edge banding comprises a blend of acrylonitrile butadiene styrene and ethylene vinyl acetate.

### DETAILED DESCRIPTION OF THE INVENTION

An edge banding comprising a blend of acrylonitrile butadiene styrene and ethylene vinyl acetate is disclosed.

In accordance with the present invention, semi rigid ABS edge banding comprises about 12% of the 18% ethylene vinyl acetate, by weight, and about 88% acrylonitrile butadiene styrene, by weight. A suitable form of ethylene vinyl acetate is sold by Lyondell Chemical Company under the name ULTRATHENE® UE624000. A suitable form of acrylonitrile butadiene styrene is sold by the Formosa Chemicals & Fibre Corp under the name TAIRILAC® AG10AP.

In one embodiment of the present invention, a semi-rigid edge banding was formed by extruding a well-mixed blend of about 12% of the 18% ethylene vinyl acetate, by weight, and about 88% acrylonitrile butadiene styrene, by weight. The thickness of the edge banding was about ⅛ inch and about 1 inch wide. The edge banding is slightly more flexible. This allows it to adhere to a smaller radius than if it were more rigid. More importantly, the stress whiting that occurs when all ABS is bent is lessened by about 80%.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. comprising a blend of acrylonitrile butadiene styrene and ethylene vinyl acetate.

2. The edge banding of claim 1 wherein said blend comprises about 12% to 20% ethylene vinyl acetate.

3. The edge banding of claim 1 wherein said blend comprises about 18% ethylene vinyl acetate.

4. The edge banding of claim 1 wherein said blend comprises about 80% to 88% acrylonitrile butadiene styrene.

5. The edge banding of claim 1 wherein said blend comprises about 82% % acrylonitrile butadiene styrene.
